(19) United States
(12) Patent Application Publication
(10) Pub. No.: US 2003/0053892 A1
(43) Pub. Date: Mar. 20, 2003

(54) Loadport equipped with automatic height adjustment means and method for operating

(75) Inventors: H.S. Lan, Nantou City (TW); Y.C. Huang, Taichung City (TW); D.M. Tseng, Ziguan (TW); C.D. Chang, Tainan (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 09/955,512

(22) Filed: Sep. 17, 2001

(51) Int. Cl. B65G 49/07

(52) U.S. Cl. 414/217

(57) ABSTRACT

A loadport for a semiconductor fabrication machine that is equipped with an automatic height adjustment means and a method for operating the loadport are described. The loadport consists of a moveable platform for carrying a wafer cassette thereon and supported by at least two support members capable of moving the platform in an up-and-down direction. A distance sensor is mounted on a bottom surface of the platform for measuring a height of the platform. A process controller is used to receive a first signal from the distance sensor, comparing to a pre-stored datum and then sending a second signal to the at least two support members to move the platform until the first signal equals the pre-stored datum.

### FIELD OF THE INVENTION

The present invention generally relates to a loadport of a semiconductor fabrication equipment for receiving a wafer cassette and more particularly, relates to a loadport for a semiconductor fabrication equipment that is equipped with automatic height adjustment means capable of maintaining the loadport at a predetermined height and a method for operating the loadport.

### BACKGROUND OF THE INVENTION

In the manufacturing of a semiconductor device, the device is usually processed at many work stations or processing machines. The transporting or conveying of partially finished devices, or work-in-process (WIP) parts, is an important aspect in the total manufacturing process. The conveying of semiconductor wafers is especially important in the manufacturing of integrated circuit chips due to the delicate nature of the chips. Furthermore, in fabricating an IC product, a multiplicity of fabrication steps, i.e., as many as several hundred, is usually required to complete the fabrication process. A semiconductor wafer or IC chips must be transported between various process stations in order to perform various fabrication processes.

For instance, to complete the fabrication of an IC chip, various steps of deposition, cleaning, ion implantation, etching and passivation steps must be carried out before an IC chip is packaged for shipment. Each of these fabrication steps must be performed in a different process machine, i.e. a chemical vapor deposition chamber, an ion implantation chamber, an etcher, etc. A partially processed semiconductor wafer must be conveyed between various work stations many times before the fabrication process is completed. The safe conveying and accurate tracking of such semiconductor wafers or work-in-process parts in a semiconductor fabrication facility is therefore an important aspect of the total fabrication process.

Conventionally, partially finished semiconductor wafers or WIP parts are conveyed in a fabrication plant by automatically guided vehicles or overhead transport vehicles that travel on predetermined routes or tracks. For the conveying of semiconductor wafers, the wafers are normally loaded into cassettes pods, such as SMIF (standard machine interface) or FOUP (front opening unified pod), and then picked up and placed in the automatic conveying vehicles. For identifying and locating the various semiconductor wafers or WIP parts being transported, the cassettes or pods are normally labeled with a tag positioned on the side of the cassette or pod. The tags can be read automatically by a tag reader that is mounted on the guard rails of the conveying vehicle.

In an automatic material handling system (AMHS), stockers are widely used in conjunction with automatically guided or overhead transport vehicles, either on the ground or suspended on tracks, for the storing and transporting of semiconductor wafers in SMIF pods or in wafer cassettes. For instance, a stocker may be provided for controlling the storage and conveying of WIP wafers to three process tools A, B and C. After a SMIF pod is delivered to one of the three tools, the SMIF pod is always returned to the stocker before it is sent to the next processing tool. This is a viable process since only one stocker is required for handling three different processing tools and that no buffer station is needed. This configuration illustrates that the frequency of use of the stocker is extremely high since the stocker itself is used as a buffer station for all three tools.

FIG. 1 illustrates a schematic of a typical automatic material handling system 20 that utilizes a central corridor 22, a plurality of bays 24 and a multiplicity of process machines 26. A multiplicity of stockers 30 are utilized for providing input/out to bay 24, or to precessing machines 26 located on the bay 24. The central corridor 22 designed for bay lay-out is frequently used in an efficient automatic material handling system to perform lot transportation between bays. In this configuration, the stockers 30 of the automatic material handling system become the pathway for both input and output of the bay. Unfortunately, the stocker 30 frequently becomes a bottleneck for internal transportation. It has been observed that a major cause for the stockers 30 to be the bottleneck is the input/output ports of the stockers.

In modern semiconductor fabrication facilities, especially for the 200 mm or 300 mm fabrication plants, automatic guided vehicles (AGV) and overhead hoist transport (OHT) are extensively used to automate the wafer transport process as much as possible. The AGE and OHT utilize the input/output ports of a stocker to load or unload wafer lots, i.e. normally stored in POUFs. FIG. 2 is a perspective view of an overhead hoist transport system 32 consisting of two vehicles 34, 36 that travel on a track 38. An input port 40 and an output port 42 are provided on the stocker 30. As shown in FIG. 2, the overhead transport vehicle 36 stops at a position for unloading a FOUP 44 into the input port 40. The second overhead transport vehicle 34 waits on track 38 for input from stocker 30 until the first overhead transport vehicle 36 moves out of the way.

Similarly, the OHT system is also used to deliver a cassette pod such as a FOUP to a process machine. This is shown in FIG. 3. A cassette pod 10 of the FOUP type is positioned on a loadport 12 of a process machine 14. The loadport 12 is frequently equipped with a plurality of locating pins for the proper positioning of the cassette pod 10. In the arrangement of FIG. 3, a wet etching apparatus is sometimes equipped with an internal buffer (or internal stocker) since a high volume of wafers is processed by the apparatus. The loadport 12 is always mounted at a standard height from the floor surface 16, i.e. at 900 mm.

The height of the loadport 12 becomes more critical when an automated guided vehicle (AGV) 28 or a rail guided vehicle (RGV) is used to automatically load a FOUP 10 onto a process machine 18. This is shown in FIG. 4.

The criticality of the loadport height is also shown in FIG. 5, in an OHT arrangement wherein a wafer cassette 10 is delivered by an OHT 32 onto a loadport 12. When the height of the loadport 12 deviates from the standard height of 900 mm, a delivery or a positioning error can occur and lead to serious delivery problems. Conventionally, the loadport is fixed in a process tool, as shown in FIG. 6. The process machine 18 is equipped with a loadport 12 which is positioned on top of a welded frame 46 that sits on manually adjustable legs 48. Problems occur when the loadport must be positioned in a drip pan (not shown) such as in the case of a wet etcher to prevent possible contamination of the fabrication facility when leaks develop. The height of the drip pan cannot be compensated by the fixed-frame loadport 12, shown in FIG. 6. Other special situations may also contribute to the variation in height of the loadport from its standard height of 900 mm. Each time such variation occurs, the delivery of a FOUP to the loadport may cause a serious mis-positioning problem.

It is therefore an object of the present invention to provide a loadport for a semiconductor fabrication equipment that does not have the drawbacks or shortcomings of the conventional loadports.

It is another object of the present invention to provide a loadport for a semiconductor fabrication equipment that is equipped with an automatic height adjustment means capable of keeping the loadport at a standard height.

It is a further object of the present invention to provide a loadport for a semiconductor fabrication equipment that is equipped with an automatic height adjustment means consisting of a distance sensor, a process controller, and at least two support members for supporting and moving the loadport in an up-and-down direction.

It is another further object of the present invention to provide a loadport for a semiconductor fabrication equipment that is equipped with an automatic height adjustment means and a leveling sensor and means.

It is still another object of the present invention to provide a loadport for a semiconductor fabrication equipment wherein the loadport may be moved up-and-down by a screw/screw rail arrangement.

It is yet another object of the present invention to provide a loadport for a semiconductor fabrication equipment that is equipped with an automated height adjustment means capable of moving the loadport up-and-down by a rack/pinion arrangement.

It is still another further object of the present invention to provide a method for automatically adjusting the height of a loadport by utilizing a distance sensor, a process controller, and at least two support members capable of moving the loadport in an up-and-down direction.

### SUMMARY OF THE INVENTION

In accordance with the present invention, a loadport for a semiconductor fabrication equipment that is equipped with automatic height adjustment and a method for operating the loadport are provided.

In a preferred embodiment, a loadport for a semiconductor fabrication machine that is equipped with an automatic height adjustment means is provided which includes a movable platform adapted for carrying a wafer cassette thereon and for moving vertically in an up-and-down direction; at least two support members for supporting the movable platform and for moving the platform in an up-and-down direction; a distance sensor mounted on a bottom surface of the movable platform for measuring a height of the movable platform; and a process controller for receiving a first signal from the distance sensor, comparing to a pre-stored datum and then sending a second signal to the at least two support members to move the movable platform until the first signal equals the pre-stored datum.

In the loadport that is equipped with automatic height adjustment means, the movable platform is a load port platform. The at least two support members are two support members spaced-apart each for supporting one of two ends of the movable platform. The at least two support members are four support members spaced-apart each for supporting one of four corners of the movable platform. The at least two support members may further include a screw and a screw rail operated by a motor for moving the movable platform in an up-and-down direction, or include a rack and a pinion operated by a motor for moving the movable platform in an up-and-down direction. The movable platform may further include a leveling sensor mounted on or adjacent to a top surface of the platform, or include a leveling sensor and a leveling means mounted on the platform. The distance sensor may be an optical sensor, or may be a sonic sensor.

The present invention is further directed to a method for automatically adjusting the height of a loadport that can be carried out by the operating steps of first providing a movable platform capable of being moved in an up-and-down direction; mounting the movable platform on at least two support members; mounting a distance sensor on a bottom surface of the movable platform; connecting a process controller to the distance sensor and the at least two support members; measuring a height of the movable platform and sending a first signal to the process controller; comparing the first signal with a pre-stored datum in the process controller and determining a deviation; and adjusting the height of the movable platform by the at least two support members until the deviation becomes zero.

The method for automatically adjusting the height of a loadport may further include the step of adjusting the height of the movable platform by the at least two support members wherein each is equipped with a screw and a screw rail operated by a motor, or wherein each is equipped with a rack and a pinion operated by a motor. The method may further include the step of mounting a leveling sensor on the movable platform and adjusting the leveling of the platform, or the step of measuring a height of the platform by using an optical type distance sensor, or the step of measuring a height of the platform by using a sonic type distance sensor. The method may further include the step of mounting the movable platform at two distant ends by two support members, or mounting the movable platform at four corners by four support members. The method may further include the step of measuring a height of the platform by an infrared sensor, or by an ultrasonic sensor.

### BRIEF DESCRIPTION OF THE DRAWINGS

These and other objects, features and advantages of the present invention will become apparent from the following detailed description and the appended drawings in which:

FIG. 1 is a schematic illustrating a conventional automatic material handling system utilizing a central corridor for intra-bay transport.

FIG. 2 is a schematic illustrating a conventional overhead hoist transport system for accessing a stocker.

FIG. 3 is a cross-sectional view of a processing equipment equipped with a loadport and an internal stocker.

FIG. 4 is a side view of a loadport on a process equipment being loaded by an automated guided vehicle system.

FIG. 5 is a side view of a loadport on a process machine being loaded by an OHT system.

FIG. 6 is a front view of a conventional loadport on a fixed, welded frame.

FIG. 7 is a side view of a present invention loadport equipped with movable support members.

FIG. 8 is a front view of the present invention loadport equipped with movable support members.

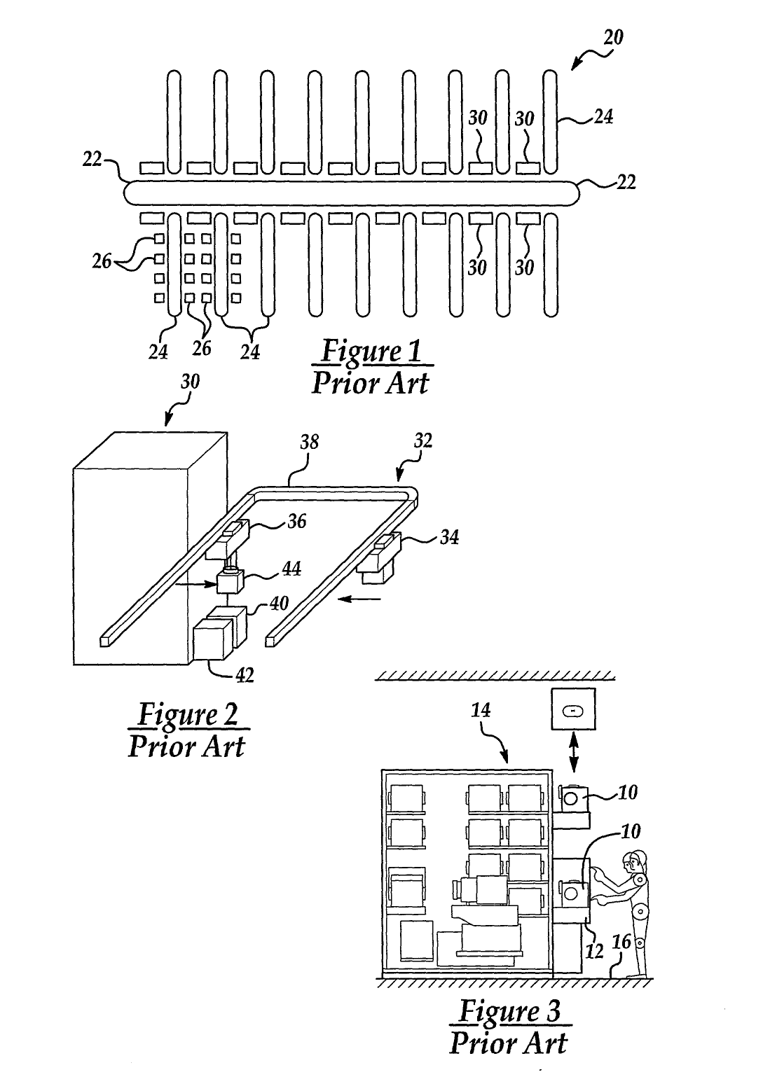

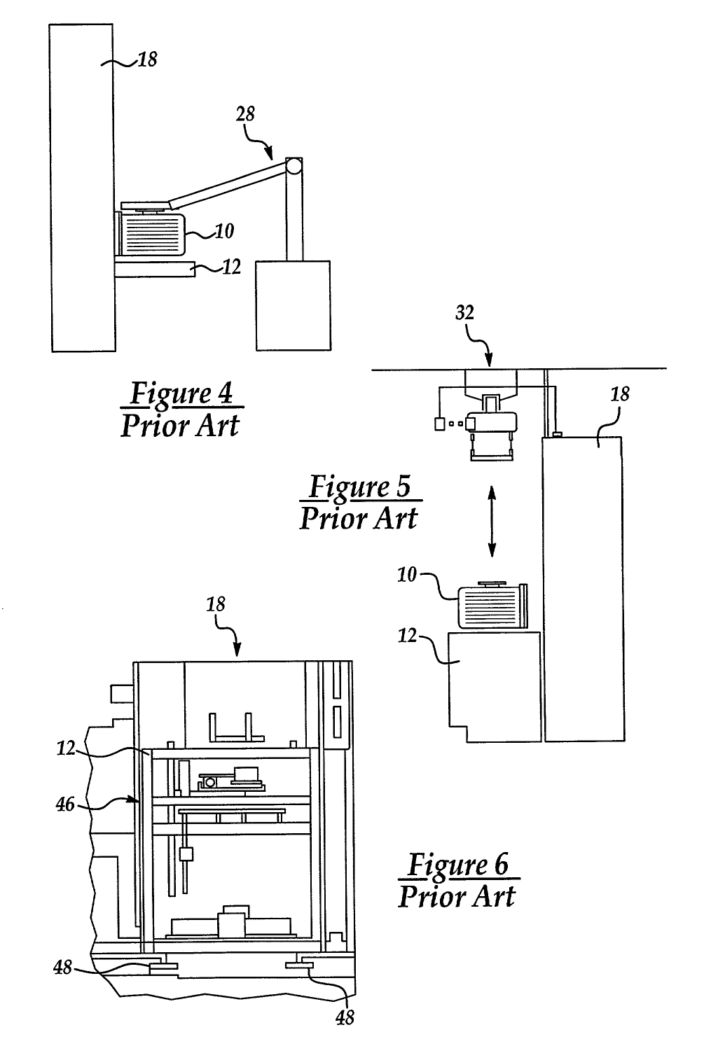

### DETAILED DESCRIPTION OF THE PREFERRED EMBODIMENT

The present invention discloses a loadport that is equipped with automatic height adjustment means for use on a semiconductor fabrication equipment and a method for operating the loadport.

The loadport for a semiconductor fabrication equipment equipped with automatic height adjustment is provided which includes a movable platform, at least two support members, a distance sensor and a process controller. The at least two support members each equipped with means for moving the platform in an up-and-down direction which may consist of a screw and a screw rail operated by a motor, or a rack and a pinion operated by a motor. The distance sensor may be of the optical type, or of the sonic type which may be mounted on a bottom surface of the movable platform for measuring a height of the platform. The at least two support members may be two, three or four support members that are spaced-apart each for supporting a corner of the movable platform and for moving the platform in an up-and-down direction. The movable platform may further include a leveling sensor and a leveling means for sensing and leveling of the platform.

The invention further discloses a method for automatically adjusting the height of a loadport which can be carried out by first providing an apparatus as previously described, and then measuring a height of the movable platform and sending a first signal to the process controller. The process controller then compares the first signal with a pre-stored datum in the process controller to determine a deviation. The height of the movable platform is then adjusted by the at least two support members until the deviation becomes zero.

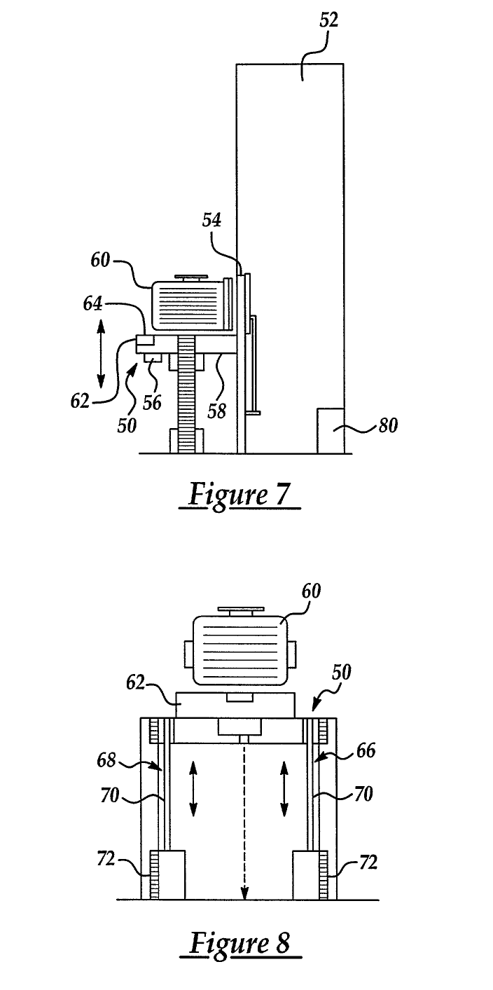

Referring now to FIG. 7, wherein a side view of a present invention loadport 50 is shown. The loadport 50 is part of a semiconductor process equipment 52 which includes a cassette door opener 54 for accessing a wafer cassette, i.e. a FOUP 60. The loadport 50 is equipped with a distance sensor 56 mounted on a bottom surface 58 of the loadport, and a leveling sensor 62 mounted in a top surface 64 of the loadport. These are also shown in a front view of the loadport 50 in FIG. 8.

The mechanism for moving the loadport platform 62 in an up-and-down direction is shown as two support members 66, 68. Each of the support members 66, 68 consists of a screw 70 and a screw rail 72. When the screw rail 72 is operated by a motor (not shown), the screw 70 and the screw rail 72 make relative motions which enables the platform 62 to be moved upwardly or downwardly.

The support members 66, 68 may further be equipped, instead of the screw/screw rail arrangement, with a rack/pinion arrangement (not shown) for achieving the same upward and downward movement. The rack/pinion arrangement is also driven by a motor.

A process controller 80 is utilized to receive a first signal from the distance sensor 56, comparing the first signal to a pre-stored datum, such as 900 mm, and then sending a second signal to the support members 66, 68 for the automatic adjustment of the height of the platform 62. The distance sensor 56 can be suitably supplied in either an infrared sensor or an ultra-sonic sensor.

The present invention loadport for a semiconductor process equipment that is equipped with an automatic height adjustment means and a method for operating the loadport have therefore been amply described in the above description and in the appended drawings of FIGS. 7 and 8.

While the present invention has been described in an illustrative manner, it should be understood that the terminology used is intended to be in a nature of words of description rather than of limitation.

Furthermore, while the present invention has been described in terms of a preferred embodiment, it is to be appreciated that those skilled in the art will readily apply these teachings to other possible variations of the inventions.

The embodiment of the invention in which an exclusive property or privilege is claimed are defined as follows.

What is claimed is:

1. A loadport equipped with automatic height adjustment means comprising:
a movable platform adapted for carrying a wafer cassette thereon and for moving vertically in an up-and-down direction;
at least two support members for supporting said movable platform and for moving said platform in an up-and-down direction;
a distance sensor mounted on a bottom surface of said movable platform for measuring a height of said movable platform; and
a process controller for receiving a first signal from said distance sensor, comparing to a pre-stored datum and then sending a second signal to said at least two support members to move said movable platform until said first signal equals said pre-stored datum.

2. A loadport equipped with automatic height adjustment means according to claim 1, wherein said movable platform is a load port platform.

3. A loadport equipped with automatic height adjustment means according to claim 1, wherein said at least two support members are two support members spaced-apart each for supporting one of two ends of said movable platform.

4. A loadport equipped with automatic height adjustment means according to claim 1, wherein said at least two support members are four support members spaced-apart each for supporting one of four corners of said movable platform.

5. A loadport equipped with automatic height adjustment means according to claim 1, wherein said at least two support members further comprises a screw and a screw rail operated by a motor for moving said movable platform in an up-and-down direction.

6. A loadport equipped with automatic height adjustment means according to claim 1, wherein said at least two support members further comprises a rack and a pinion operated by a motor for moving said movable platform in an up-and-down direction.

7. A loadport equipped with automatic height adjustment means according to claim 1, wherein said movable platform further comprises a leveling sensor mounted on or adjacent to a top surface of said platform.

8. A loadport equipped with automatic height adjustment means according to claim 1, wherein said movable platform further comprises a leveling sensor and a leveling means mounted on said platform.

9. A loadport equipped with automatic height adjustment means according to claim 1, wherein said distance sensor is an optical sensor.

10. A loadport equipped with automatic height adjustment means according to claim 1, wherein said distance sensor is a sonic sensor.

11. A method for automatically adjusting the height of a loadport comprising the steps of:
providing a movable platform capable of being moved in an up-and-down direction;
mounting the movable platform on at least two support members;
mounting a distance sensor on a bottom surface of said movable platform;
connecting a process controller to said distance sensor and said at least two support members;
measuring a height of said movable platform and sending a first signal to said process controller;
comparing said first signal with a pre-stored datum in said process controller and determining a deviation; and
adjusting the height of said movable platform by said at least two support members until said deviation becomes zero.

12. A method for automatically adjusting the height of a loadport according to claim 11 further comprising the step of adjusting the height of said movable platform by said at least two support members wherein each being equipped with a screw and a screw rail operated by a motor.

13. A method for automatically adjusting the height of a loadport according to claim 11 further comprising the step of adjusting the height of said movable platen by said at least two support members wherein each being equipped with a rack and a pinion operated by a motor.

14. A method for automatically adjusting the height of a loadport according to claim 11 further comprising the step of mounting a leveling sensor on said movable platform and adjusting the leveling of said platform.

15. A method for automatically adjusting the height of a loadport according to claim 11 further comprising the step of measuring a height of said platform by using an optical type distance sensor.

16. A method for automatically adjusting the height of a loadport according to claim 11 further comprising the step of measuring a height of said platform by using a sonic type distance sensor.

17. A method for automatically adjusting the height of a loadport according to claim 11 further comprising the step of mounting the movable platform at two distant ends by two support members.

18. A method for automatically adjusting the height of a loadport according to claim 11 further comprising the step of mounting the movable platform at four corners by four support members.

19. A method for automatically adjusting the height of a loadport according to claim 11 further comprising the step of measuring a height of the platform by an infrared sensor.

20. A method for automatically adjusting the height of a loadport according to claim 11 further comprising the step of measuring a height of the platform by an ultrasonic sensor.
